(19) United States
(12) Patent Application Publication
(10) Pub. No.: US 2021/0185344 A1
(43) Pub. Date: Jun. 17, 2021

(54) IMAGE DECODING DEVICE, IMAGE ENCODING DEVICE, PROGRAM, AND IMAGE PROCESSING SYSTEM

(71) Applicant: KDDI CORPORATION, Tokyo (JP)

(72) Inventors: Kyohei UNNO, Fujimino-shi (JP); Kei KAWAMURA, Fujimino-shi (JP); Sei NAITO, Fujimino-shi (JP)

(73) Assignee: KDDI CORPORATION, Tokyo (JP)

(21) Appl. No.: 17/187,954

(22) Filed: Mar. 1, 2021

Related U.S. Application Data
(63) Continuation of application No. PCT/JP2019/041872, filed on Oct. 25, 2019.

(30) Foreign Application Priority Data
Dec. 27, 2018 (JP) 2018-245895

(51) Int. Cl. H04N 19/513; H04N 19/122; H04N 19/105; H04N 19/176

(52) U.S. Cl. CPC H04N 19/513; H04N 19/176; H04N 19/105; H04N 19/122

(57) ABSTRACT

An image decoding device includes a motion-vector decoding unit that acquires a motion vector from the encoded data; and a refinement unit that changes, using information concerning at least one of width and height of a block in which the motion vector is used, a region used for refinement of the motion vector.

### CROSS-REFERENCE TO RELATED APPLICATIONS

The present application is a continuation based on PCT Application No. PCT/JP2019/041872, filed on Oct. 25, 2019, which claims the benefit of Japanese patent application No. 2018-245895 on Dec. 27, 2018. The entire contents of which are hereby incorporated by reference.

### TECHNICAL FIELD

The present invention relates to an image decoding device, an image coding device, a program, and an image processing system.

### BACKGROUND

CE9-related: Simplified DMVR with reduced internal memory, JVET-L0098 and CE9-related: DMVR with Coarse-to-Fine Search and Block Size Limit, JVET-L0382 disclose, concerning a technique called decoder-side motion vector refinement (DMVR), a technique for, in order to reduce a memory use amount and a search cost calculation amount during execution, prohibiting application of the DMVR in a block of a size equal to or larger than a threshold or dividing the block of the size equal to or larger than the threshold into small sub-blocks and executing the DMVR for each of the sub-blocks.

### SUMMARY

However, in the related art described above, there is a problem in that, when the application of the DMVR in a large block is simply prohibited, depending on the threshold, encoding efficiency is greatly deteriorated compared with when the application of the DMVR is not prohibited.

In the related art described above, there is a problem in that, when the DMVR is executed for each of the sub-blocks, it is likely that a value of a motion vector is different for each of the sub-blocks and block noise easily occurs.

Therefore, the present invention has been devised in view of the above problems, and an object of the present invention is to provide an image decoding device, an image encoding device, a program, and an image processing system that can reduce memories, an arithmetic processing amount, and the number of arithmetic circuits necessary for execution of DMVR while suppressing deterioration in encoding efficiency.

The first aspect of the present invention is summarized as an image decoding device configured to decode encoded data, the image decoding device including: a decoder that acquires a motion vector from the encoded data; and a circuit that changes, using information concerning at least one of width and height of a block in which the motion vector is used, a region used for refinement of the motion vector.

The second aspect of the present invention is summarized as an image encoding device configured to generate encoded data by encoding an input image signal, the image encoding device including: a first circuit that searches for a motion vector through comparison of a target frame and a reference frame; and a second circuit changes, using information concerning at least one of width and height of a block in which the motion vector is used, a region used for refinement of the motion vector.

The third aspect of the present invention is summarized as a program for causing a computer to function as an image decoding device configured to decode encoded data, the image decoding device including: a decoder that acquires a motion vector from the encoded data; and a circuit that changes, using information concerning at least one of width and height of a block in which the motion vector is used, a region used for refinement of the motion vector.

The fourth aspect of the present invention is summarized as an image processing system including: an image encoding device configured to generate encoded data by encoding an input image signal and an image decoding device configured to decode the encoded data, wherein the image encoding device includes: a first circuit that searches for a motion vector through comparison of a target frame and a reference frame; and a second circuit changes, using information concerning at least one of width and height of a block in which the motion vector is used, a region used for refinement of the motion vector; and the image decoding device includes: a decoder that acquires the motion vector from the encoded data; and a circuit that changes, using the information, a region used for refinement of the motion vector.

According to the present invention, it is possible to provide an image decoding device, an image encoding device, a program, and an image processing system that can reduce memories, an arithmetic processing amount, and the number of arithmetic circuits necessary for execution of DMVR while suppressing deterioration in encoding efficiency.

### BRIEF DESCRIPTION OF DRAWINGS

FIG. 1 is a diagram illustrating an example of the configuration of an image processing system 10 according to an embodiment.

FIG. 2 is a diagram illustrating an example of functional blocks of an image encoding device 100 of the image processing system 10 according to the embodiment.

FIG. 3 is a diagram illustrating an example of functional blocks of an inter prediction unit 111 of the image encoding device 100 according to the embodiment.

FIG. 4 is a flowchart illustrating an example of a procedure of refinement processing performed by a refinement unit 111B of the inter prediction unit 111 of the image encoding device 100 (a refinement unit 241B of an inter prediction unit 241 of an image decoding device 200) in the embodiment.

FIG. 5 is a diagram illustrating an example of a region used for refinement of a motion vector in the refinement processing performed by the refinement unit 111B of the inter prediction unit 111 of the image encoding device 100 (the refinement unit 241B of the inter prediction unit 241 of the image decoding device 200) in the embodiment.

FIG. 6 is a diagram illustrating an example of the region used for the refinement of the motion vector in the refinement processing performed by the refinement unit 111B of the inter prediction unit 111 of the image encoding device 100 (the refinement unit 241B of the inter prediction unit 241 of the image decoding device 200) in the embodiment.

FIG. 7 is a flowchart illustrating an example of a procedure for determining a shape of the region used for the refinement the motion vector performed by the refinement unit 111B of the inter prediction unit 111 of the image encoding device 100 (the refinement unit 241B of the inter prediction unit 241 of the image decoding device 200) in the embodiment.

FIG. 8 is a diagram illustrating an example of functional blocks of the image decoding device 200 of the image processing system 10 according to the embodiment.

FIG. 9 is a diagram illustrating an example of functional blocks of the inter prediction unit 241 of the image decoding device 200 according to the embodiment.

FIG. 10 is a flowchart illustrating an example of a procedure of the refinement processing performed by the refinement unit 111B of the inter prediction unit 111 of the image encoding device 100 (the refinement unit 241B of the inter prediction unit 241 of the image decoding device 200) in the embodiment.

FIG. 11 is a flowchart illustrating an example of a procedure of refinement processing performed by the refinement unit 111B of the inter prediction unit 111 of the image encoding device 100 (the refinement unit 241B of the inter prediction unit 241 of the image decoding device 200) in a modification.

FIG. 12 is a diagram illustrating an example of a table used in the refinement unit 111B of the inter prediction unit 111 of the image encoding device 100 (the refinement unit 241B of the inter prediction unit 241 of the image decoding device 200) in the modification.

FIG. 13 is a flowchart illustrating an example of the procedure of the refinement processing performed by the refinement unit 111B of the inter prediction unit 111 of the image encoding device 100 (the refinement unit 241B of the inter prediction unit 241 of the image decoding device 200) in the modification.

FIG. 14 is a flowchart illustrating an example of a procedure of refinement processing performed by the refinement unit 111B of the inter prediction unit 111 of the image encoding device 100 (the refinement unit 241B of the inter prediction unit 241 of the image decoding device 200) in a modification.

FIG. 15 a diagram illustrating an example of a region used in refinement of a motion vector in the refinement processing performed by the refinement unit 111B of the inter prediction unit 111 of the image encoding device 100 (the refinement unit 241B of the inter prediction unit 241 of the image decoding device 200) in the modification.

### DETAILED DESCRIPTION

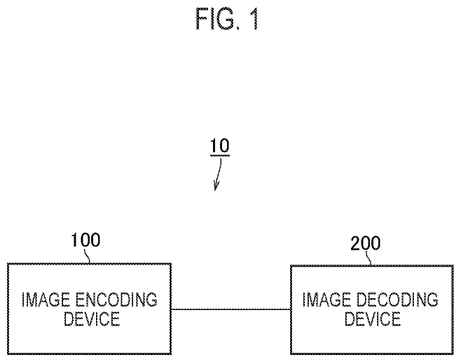

An image processing system 10 according to a first embodiment of the present invention is explained below with reference to FIG. 1 to FIG. 10. FIG. 1 is a diagram illustrating the image processing system 10 according to an embodiment according to this embodiment.

As illustrated in FIG. 1, the image processing system 10 includes an image encoding device 100 and an image decoding device 200.

The image encoding device 100 is configured to encode an input image signal to thereby generate encoded data. The image decoding device 200 is configured to decode the encoded data to generate an output image signal.

Such encoded data may be transmitted from the image encoding device 100 to the image decoding device 200 via a transmission line. The encoded data may be stored in a storage medium and then provided from the image encoding device 100 to the image decoding device 200.

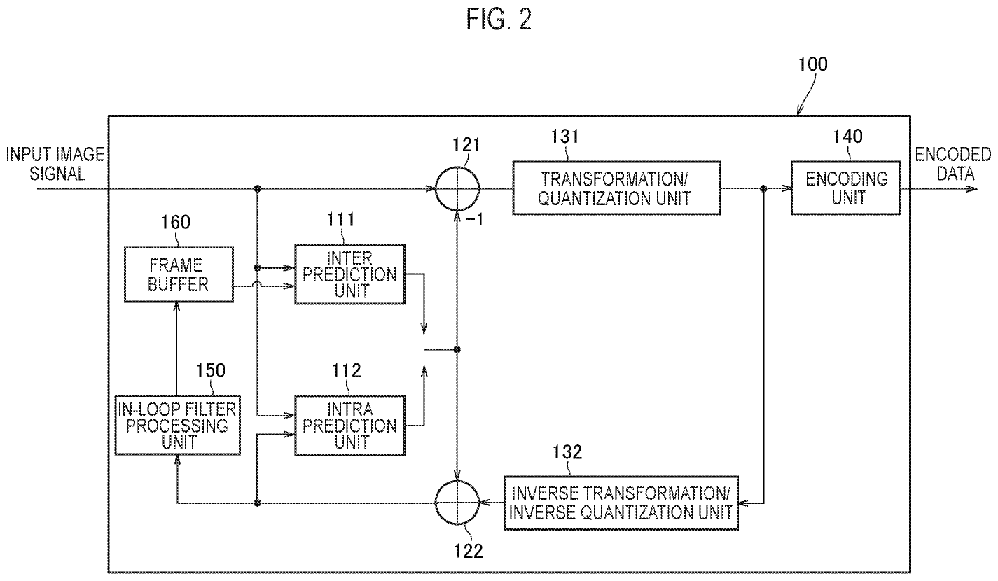

The image encoding device 100 according to this embodiment is explained below with reference to FIG. 2. FIG. 2 is a diagram illustrating an example of functional blocks of the image encoding device 100 according to this embodiment.

As illustrated in FIG. 2, the image encoding device 100 includes an inter prediction unit 111, an intra prediction unit 112, a subtractor 121, an adder 122, a transformation/quantization unit 131, an inverse transformation/inverse quantization unit 132, an encoding unit 140, an in-loop filter processing unit 150, and a frame buffer 160.

The inter prediction unit 111 is configured to generate a prediction signal through inter prediction (inter-frame prediction).

Specifically, the inter prediction unit 111 is configured to specify, through comparison of an encoding target frame (hereinafter, target frame) and a reference frame stored in the frame buffer 160, a reference block included in the reference frame and determine a motion vector with respect to the specified reference block.

The inter prediction unit 111 is configured to generate, based on the reference block and the motion vector, for each prediction block, the prediction signal included in the prediction block. The inter prediction unit 111 is configured to output the prediction signal to the subtractor 121 and the adder 122. The reference frame is a frame different from the target frame.

The intra prediction unit 112 is configured to generate the prediction signal through intra prediction (intra-frame prediction).

Specifically, the intra prediction unit 112 is configured to specify the reference block included in the target frame and generate, for each prediction block, the prediction signal based on the specified reference block. The intra prediction unit 112 is configured to output the prediction signal to the subtractor 121 and the adder 122.

The reference block is a block referred to about a prediction target block (hereinafter, target block). For example, the reference block is a block adjacent to the target block.

The subtractor 121 is configured to subtract the prediction signal from the input image signal and output a prediction remainder signal to the transformation/quantization unit 131. The subtractor 121 is configured to generate the prediction remainder signal, which is a difference between the prediction signal generated by the intra prediction or the inter prediction and the input image signal.

The adder 122 is configured to add the prediction signal to the prediction remainder signal output from the inverse transformation/inverse quantization unit 132 to generate a pre-filter processing decoded signal and output such a pre-filter processing decoded signal to the intra prediction unit 112 and the in-loop filter processing unit 150.

The pre-filter processing decoded signal configures the reference block used in the intra prediction unit 112.

The transformation/quantization unit 131 is configured to perform transformation processing of the prediction remainder signal and acquire a coefficient level value. Further, the transformation/quantization unit 131 may be configured to perform quantization of the coefficient level value.

The transformation processing for transforming the prediction remainder signal into a frequency component signal. In such transformation processing, a base pattern (a transformation matrix) corresponding to discrete cosine transform (DCT) may be used or a base pattern (a transformation matrix) corresponding to discrete sine transform (DST) may be used.

The inverse transformation/inverse quantization unit 132 is configured to perform inverse transformation processing of the coefficient level value output from the transformation/quantization unit 131. The inverse transformation/inverse quantization unit 132 is configured to perform inverse quantization of the coefficient level value prior to the inverse transformation processing.

The inverse transformation processing and the inverse quantization are performed in a procedure opposite to the transformation processing and the quantization performed in the transformation/quantization unit 131.

The encoding unit 140 is configured to encode the coefficient level value output from the transformation/quantization unit 131 and output encoded data.

For example, the encoding is entropy encoding for allocating a code of different length based on an occurrence probability of the coefficient level value.

The encoding unit 140 is configured to encode, in addition to the coefficient level value, control data used in decoding processing.

The control data may include size data such as an encoding block (CU: Coding Unit) size, a prediction block (PU: Prediction Unit) size, and a transformation block (TU: Transform Unit) size.

The in-loop filter processing unit 150 is configured to perform filter processing on the pre-filter processing decoded signal output from the adder 122 and output a post-filter processing decoded signal to the frame buffer 160.

For example, the filter processing is deblocking filter processing for reducing distortion that occurs in a boundary portion of a block (an encoding block, a prediction block, or a transformation block).

The frame buffer 160 is configured to accumulate the reference frame used in the inter prediction unit 111.

The post-filter processing decoded signal configures the reference frame used in the inter prediction unit 111.

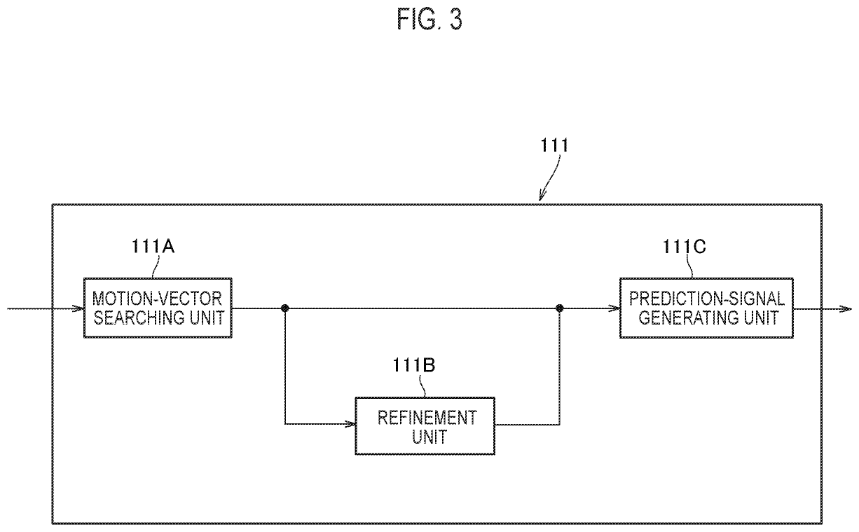

The inter prediction unit 111 of the image encoding device 100 according to this embodiment is explained below with reference to FIG. 3. FIG. 3 is a diagram illustrating an example of functional blocks of the inter prediction unit 111 of the image encoding device 100 according to this embodiment.

As illustrated in FIG. 3, the inter prediction unit 111 includes a motion-vector searching unit (first circuit) 111A, a refinement unit (second circuit) 111B, and a prediction-signal generating unit 111C.

The inter prediction unit 111 is an example of a predicting unit configured to generate the prediction signal included in the prediction block based on the motion vector.

The motion-vector searching unit 111A is configured to specify the reference block included in the reference frame through comparison of the target frame and the reference frame and search for a motion vector for the specified reference block.

Note that, concerning a searching method for a motion vector, a known method can be adopted. Therefore, details of the searching method are omitted.

The refinement unit 111B is configured to execute refinement processing for setting a searching range based on a reference position specified by the motion vector, specifying, out of the searching range, a corrected reference position where predetermined cost is the smallest, and correcting the motion vector based on the corrected reference position.

The refinement unit 111B is configured to execute such refinement processing when predetermined conditions are satisfied.

The predetermined conditions may include a condition that the motion vector is encoded in a merge mode. Note that the merge mode is a mode in which only an index of a motion vector of an encoding block adjacent to the prediction block is transmitted. The predetermined conditions may include a condition that motion compensation prediction using affine transformation is not applied to the motion vector.

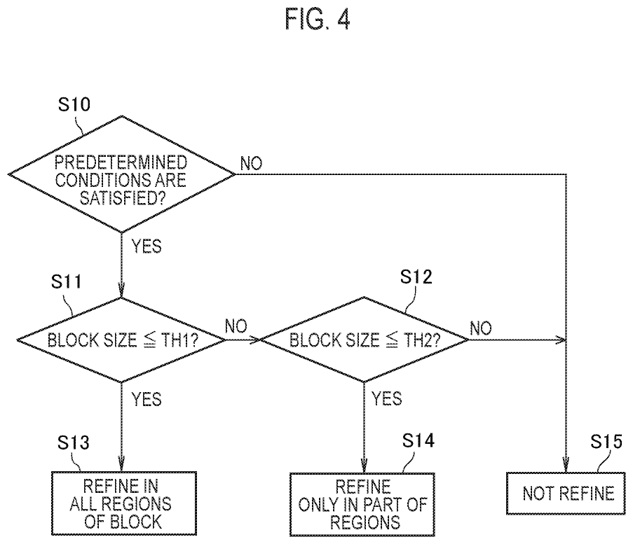

In this embodiment, the refinement unit 111B is configured to perform the refinement processing in a procedure explained below. FIG. 4 is flowchart illustrating an example of a procedure of the refinement processing performed by the refinement unit 111B of the inter prediction unit 111 of the image encoding device 100 in this embodiment.

As illustrated in FIG. 4, in step S10, the refinement unit 111B determines whether the predetermined conditions are satisfied.

When it is determined that the predetermined conditions are satisfied, this procedure proceeds to step S11. When it is determined that the predetermined conditions are not satisfied, this procedure proceeds to step S15 and ends this processing.

In step S11, the refinement unit 111B determines whether a size of a block currently being processed is equal to or smaller than a predetermined threshold TH1 (a first threshold). Note that, in the following explanation, a procedure for controlling processing according to a size of the prediction block as a type of a block is explained. However, the same control is possible when a size of the encoding block is used.

When it is determined that the size of the block is equal to or smaller than the threshold TH1, this procedure proceeds to step S13. When it is determined that the size of the block is larger than the threshold TH1, this procedure proceeds to step S12.

The threshold TH1 can be defined by, for example, the width (the number of pixels in the horizontal direction) of the block, the height (the number of pixels in the vertical direction) of the block, a total number of pixels (a product of the width and the height) in the block, and a combination of the width, the height, and the total number of pixels. In this embodiment, the threshold is defined by the total number of pixels in the block. Specifically, the following processing is explained with reference to an example in which the threshold TH1 is set to 1024 pixels.

In step S12, the refinement unit 111B determines whether a size of a prediction block currently being processed is equal to or smaller than a predetermined threshold TH2 (a second threshold).

When it is determined that the size of the prediction block is equal to or smaller than the threshold TH2, this procedure proceeds to step S14. When it is determined that the size of the prediction block is larger than the threshold TH2, this procedure proceeds to step S15.

Like the threshold TH1, the threshold TH2 can be defined by, for example, the width (the number of pixels in the horizontal direction) of the block, the height (the number of pixels in the vertical direction) of the block, a total number of pixels (a product of the width and the height) in the block, and a combination of the width, the height, and the total number of pixels.

The threshold TH2 can also be set considering a parallel processing unit of encoding processing and decoding processing. For example, when a maximum size of the prediction block is 128×128 pixels and the parallel processing unit is 64×64 pixels, the threshold TH2 can be set as 64×64 pixels or 4096 pixels.

In step S13, the refinement unit 111B executes motion vector refinement processing in a general method. When performing a search for a motion vector in the refinement processing, the refinement unit 111B performs processing using pixels in all regions in the block. Note that, concerning a searching method for a motion vector, a known method can be adopted. Therefore, details of the searching method are omitted.

“Pixels in all regions” is described above. However, the refinement unit 111B does not always need to perform the refinement processing using all pixels in the block. For example, the refinement unit 111B can also combine the refinement processing with a reducing method for a computation amount and arithmetic circuits for performing the refinement processing using only pixels on even number lines in the block.

In step S14, the refinement unit 111B executes the motion vector refinement processing using only pixels in a part of regions in the prediction block currently being processed.

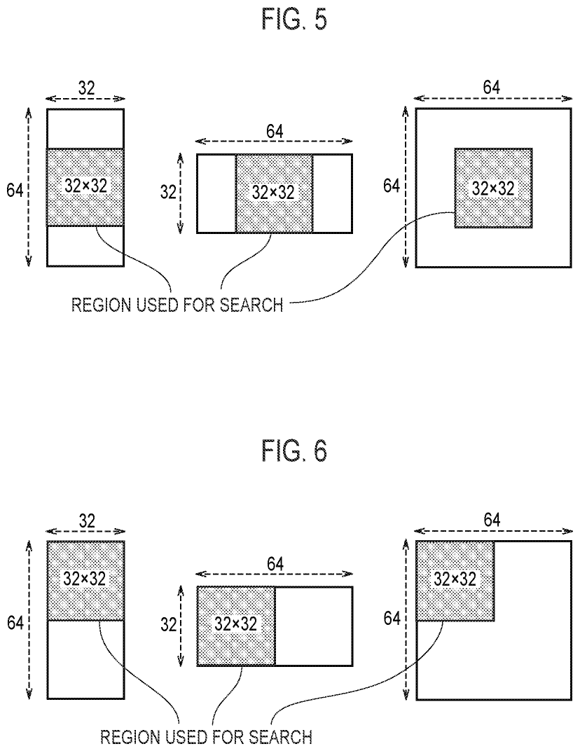

The refinement unit 111B only has to determine, in advance, a region used for the refinement of the motion vector. For example, as the region used for the refinement of the motion vector, the refinement unit 111B may use a region in the center of the block as illustrated in FIG. 5 or may use a region on the upper left of the block as illustrated in FIG. 6.

Note that the refinement unit 111B may define, in advance, for each shape of a block (a combination of the width and the height of the block) on which the processing in step S14 can be executed, which region is used or may represent a region with a uniquely determinable formula.

For example, when the region used for the refinement of the motion vector is a rectangular region and coordinates of a start point (a vertex on the upper left of a rectangle) and an end point (a vertex on the lower right of the rectangle) are respectively represented in a form of (x, y), the refinement unit 111B can also define the region with a formula like a start point (width of the block/2-16, height of the block/2-16) and an end point (width of the block/2+16, height of the block/2+16).

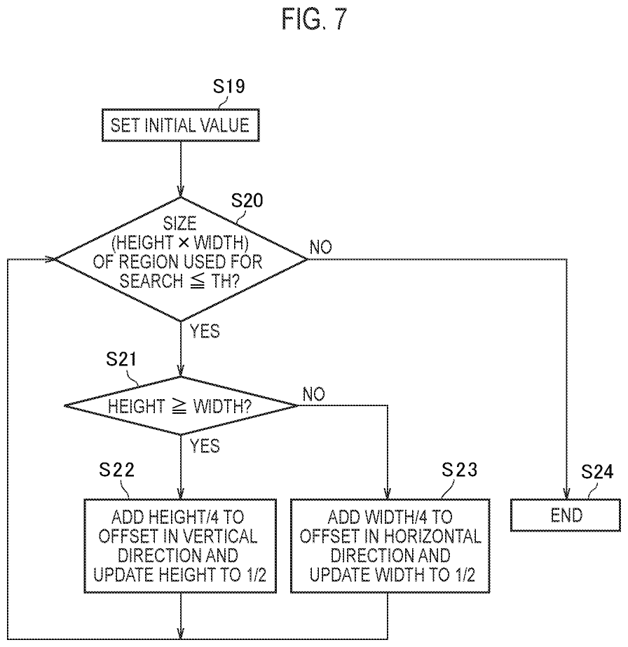

For example, the refinement unit 111B can also set the region used for the refinement of the motion vector in the block center and determine the shape of the region used for the refinement of the motion vector according to a flowchart illustrated in FIG. 7.

As illustrated in FIG. 7, in step S19, the refinement unit 111B sets an initial value of information concerning the region used for the refinement.

The information concerning the region used for the refinement is configured from, for example, four kinds of information including offset values (an offset in the horizontal direction and an offset in the vertical direction) indicating a coordinate of the vertex on the upper left of the region used for the refinement and the size (width, height) of the region used for the refinement. Note that the offset values described above represent a relative coordinate from the coordinate of the vertex on the upper left of the prediction block currently being processed.

The region used for the refinement is represented as follows by the coordinates (x, y) of the start point and the end point explained above: the start point (an offset in the horizontal direction, an offset in the vertical direction) and the end point (an offset in the horizontal direction+width, an offset in the vertical direction+height).

In this embodiment, initial values of the offsets in the horizontal direction and the vertical direction are respectively set to 0 and initial values of the width and the height are respectively set to values of the width and the height of the prediction block currently being processed. After the initial value setting, this procedure proceeds to step S20.

In step S20, the refinement unit 111B determines whether a size of the region used for such refinement is equal to or smaller than the threshold TH.

When it is determined that the size of the region is equal to or smaller than the threshold TH, this procedure proceeds to step S24, decides the size of the region used for such refinement, and ends. When it is determined that the size of the region is larger than the threshold TH, this procedure proceeds to step S21.

In step S21, the refinement unit 111B compares the sizes of the height and the width of the region used for such refinement. When the height is equal to or larger than the width, this procedure proceeds to step S22. When the width is larger than the height, this procedure proceeds to step S23.

In step S22, the refinement unit 111B adds a value of ¼ of the height to the offset in the vertical direction. Thereafter, the refinement unit 111B updates the height of the region used for such refinement with a value of ½.

In step S23, the refinement unit 111B adds a value of ¼ of the width to the offset in the horizontal direction. Thereafter, the refinement unit 111B updates the width of the region used for such refinement with a value of ½.

After step S22 or step S23 is completed, this procedure returns to step S20. The refinement unit 111B determines, again, the size of the region used for such refinement. The refinement unit 111B can determine the region used for such refinement by repeating the above processing until the size of the region used for such refinement becomes equal to or smaller than a preset threshold.

Note that, in step S14, the size of the region used for such refinement may be set to be equal to or smaller than the threshold TH1.

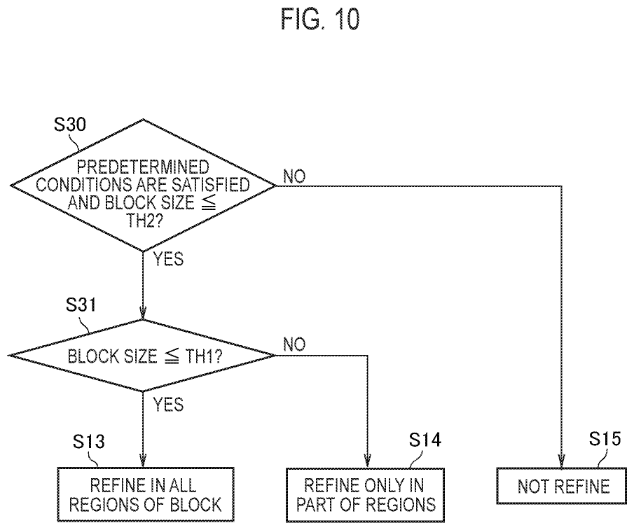

Note that, in a processing procedure illustrated in FIG. 10, the same processing result as the processing result of the processing illustrated in FIG. 4 can be obtained.

In processing illustrated in FIG. 10, first, in step S30, the refinement unit 111B determines whether the predetermined conditions described above are satisfied and the size of the prediction block being currently processed is equal to or smaller than the threshold TH2.

When it is determined that all of these conditions are satisfied, this procedure proceeds to step S31. When it is determined that at least any one of these conditions is not satisfied, this procedure proceeds to step S15 and ends the processing.

When it is determined in step S31 that the size of the prediction block currently being processed is equal to or smaller than the threshold TH1, this procedure proceeds to step S13. Otherwise, this procedure proceeds to step S14.

The following processing is the same as the processing explained with reference to FIG. 4 above.

The prediction-signal generating unit 111C is configured to generate a prediction signal based on the motion vector. Specifically, the prediction-signal generating unit 111C is configured to, when the motion vector is not corrected, generate a prediction signal based on a motion vector input from the motion-vector searching unit 111A. On the other hand, the prediction-signal generating unit 111C is configured to, when the motion vector is corrected, generate a prediction signal based on the corrected motion vector input from the refinement unit 111B.

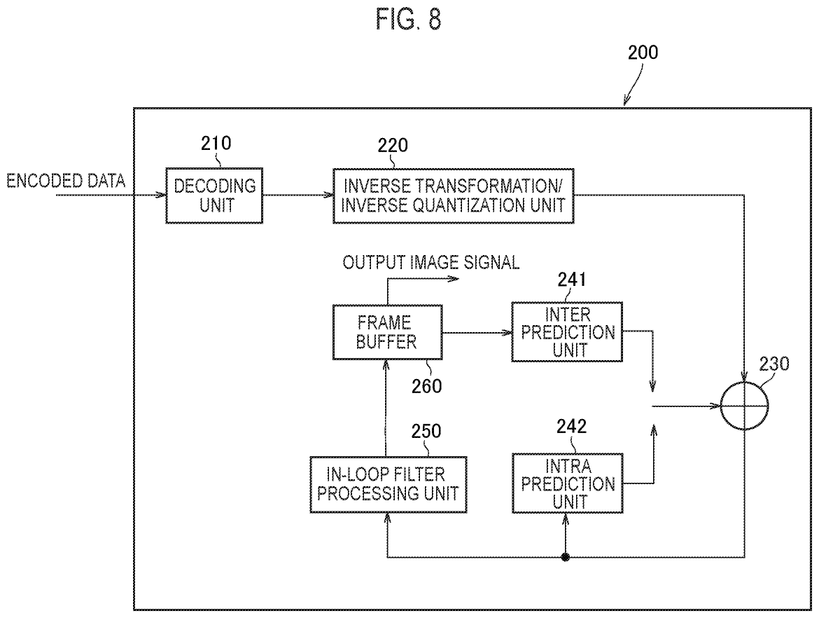

The image decoding device 200 according to this embodiment is explained below with reference to FIG. 8. FIG. 8 is a diagram illustrating an example of functional blocks of the image decoding device 200 according to this embodiment.

As illustrated in FIG. 8, the image decoding device 200 includes a decoding unit 210, an inverse transformation/inverse quantization unit 220, an adder 230, an inter prediction unit 241, an intra prediction unit 242, an in-loop filter processing unit 250, and a frame buffer 260.

The decoding unit 210 is configured to decode encoded data generated by the image encoding device 100 and decode a coefficient level value.

For example, the decoding is entropy decoding in a procedure opposite to the entropy encoding performed by the encoding unit 140.

The decoding unit 210 may be configured to acquire control data through decoding processing of the encoded data.

Note that, as explained above, the control data may include size data such as an encoding block size, a prediction block size, and a transform block size. Note that the control data may include an information element indicating an input source used for generation of a prediction sample of a second component.

The inverse transformation/inverse quantization unit 220 is configured to perform inverse transformation processing of the coefficient level value output from the decoding unit 210. The inverse transformation/inverse quantization unit 220 may be configured to perform inverse quantization of the coefficient level value prior to the inverse transformation processing.

The inverse transformation processing and the inverse quantization are performed in a procedure opposite to the transformation processing and the quantization performed in the transformation/quantization unit 131.

The adder 230 is configured to add a prediction signal to a prediction remainder signal output from the inverse transformation/inverse quantization unit 220 to generate a pre-filter processing decoded signal and output the pre-filter processing decoded signal to the intra prediction unit 242 and the in-loop filter processing unit 250.

The pre-filter processing decoded signal configures a reference block used in the intra prediction unit 242.

Like the inter prediction unit 111, the inter prediction unit 241 is configured to generate a prediction signal through inter prediction (inter-frame prediction).

Specifically, the inter prediction unit 241 is configured to generate, for each prediction block, a prediction signal based on the motion vector decoded from the encoded data and the reference signal included in the reference frame. The inter prediction unit 241 is configured to output the prediction signal to the adder 230.

Like the intra prediction unit 112, the intra prediction unit 242 is configured to generate a prediction signal through intra prediction (intra-frame prediction).

Specifically, the intra prediction unit 242 is configured to specify a reference block included in a target frame and generate, for each prediction block, a prediction signal based on the specified reference block. The intra prediction unit 242 is configured to output the prediction signal to the adder 230.

Like the in-loop filter processing unit 150, the in-loop filter processing unit 250 is configured to perform filter processing on the pre-filter processing decoded signal output from the adder 230 and output a post-filter processing decoded signal to the frame buffer 260.

For example, the filter processing is deblocking filter processing for reducing distortion that occurs in a boundary portion of a block (an encoding block, a prediction block, or a transformation block).

Like the frame buffer 160, the frame buffer 260 is configured to accumulate the reference frame used in the inter prediction unit 241.

The post-filter processing decoded signal configures the reference frame used in the inter prediction unit 241.

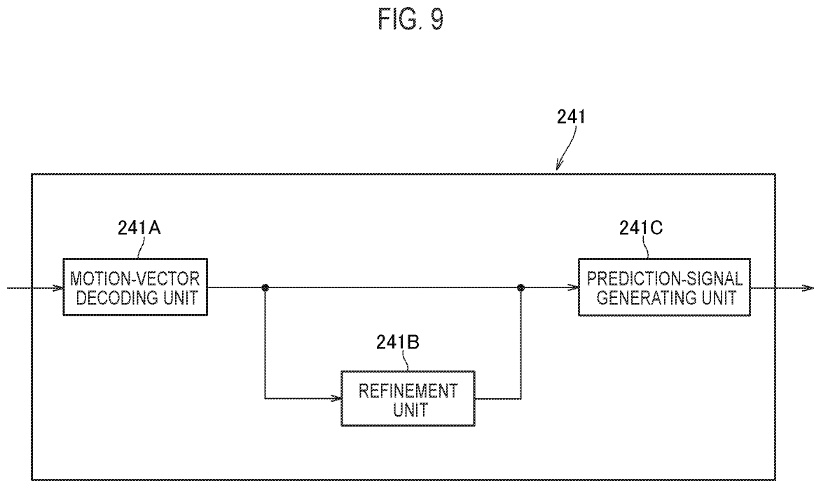

The inter prediction unit 241 according to this embodiment is explained with reference to FIG. 9. FIG. 9 is a diagram illustrating an example of functional blocks of the inter prediction unit 241 according to this embodiment.

As illustrated in FIG. 9, the inter prediction unit 241 includes a motion-vector decoding unit (decoder) 241A, a refinement unit (circuit) 241B, a prediction-signal generating unit 241C.

The inter prediction unit 241 is an example of a prediction unit configured to generate, based on a motion vector, a prediction signal included in a prediction block.

The motion-vector decoding unit 241A is configured to acquire a motion vector through decoding of control data received from the image encoding device 100.

Like the refinement unit 111B, the refinement unit 241B is configured to execute refinement processing for correcting, according to a block size, the motion vector using pixels in all regions in a block or a part of the regions in the block.

Alternatively, like the refinement unit 111B, the refinement unit 241B is configured to determine, according to the block size, not to execute the refinement processing and end the processing.

Like the prediction-signal generating unit 111C, the prediction-signal generating unit 241C is configured to generate a prediction signal based on the motion vector.

The image encoding device 100 and the image decoding device 200 according to this embodiment execute, in a block larger than the predetermined threshold TH1, the motion vector refinement processing using only pixels in a part of regions in the block.

That is, by limiting regions used for the refinement processing in the large block, it is possible to reduce memories and arithmetic circuits necessary for searching for the motion vector compared with when regions are not limited.

At this time, by setting the size of the region used for the refinement of the motion vector to be equal to or smaller than the threshold TH1, it is possible to limit maximum values of the memories and the arithmetic circuits necessary for the refinement processing of the motion vector to amounts necessary for processing the block size of the threshold TH1.

In this way, even in the large block, by executing the refinement processing of the motion vector while limiting the regions of the pixels in use, it is possible to reduce a memory amount, a computation amount, and arithmetic circuits while suppressing deterioration in encoding efficiency.

Compared with when the refinement processing is simply prohibited in the large block in order to reduce a memory amount and the like, it is possible to execute the refinement processing in a larger block. Therefore, improvement of the encoding efficiency is expected.

In refinement by sampling in a line unit disclosed in CE9-related: Simplification of Decoder Side Motion Vector Derivation, JVET-K0105, a computation amount concerning cost calculation (for example, an absolute value differential sum) during a search for a motion vector can be reduced. However, when a search point is a non-integer pixel position, pixel values of an entire block are necessary for filtering. Therefore, a memory amount for storing reference pixels cannot be reduced.

On the other hand, the image encoding device 100 and the image decoding device 200 according to this embodiment perform the refinement processing using only the pixels in a part of the regions in the block. Therefore, both of the cost calculation and the memory amount can be reduced.

Note that the image encoding device 100 and the image decoding device 200 according to this embodiment may be combined with the sampling in the line unit explained above. In this case, the computation amount and the arithmetic circuits relating to the cost calculation can be further reduced.

The image encoding device 100 and the image decoding device 200 according to this embodiment do not perform the refinement processing in a block larger than the predetermined threshold TH2.

That is, when a maximum size of the prediction block is larger than a parallel processing unit in the image encoding device 100 and the image decoding device 200, by setting the threshold TH2 to be equal to or smaller than the parallel processing unit, parallel processing in a processing unit in the refinement processing can be guaranteed.

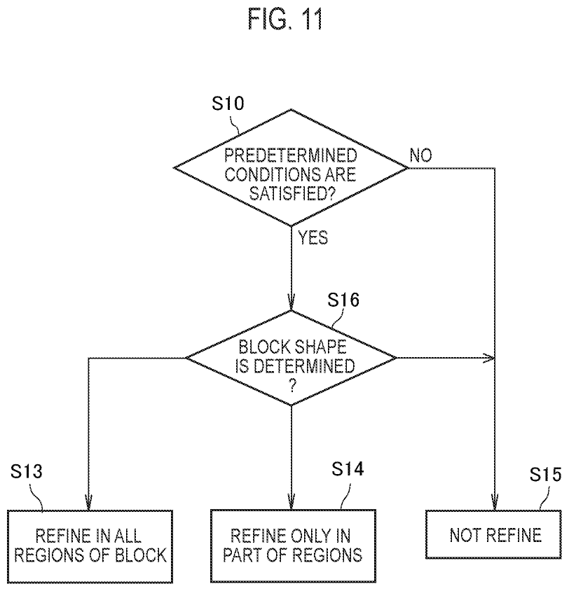

A modification 1 according to the present invention is explained below with reference to FIG. 11 to FIG. 13 focusing on differences from the first embodiment explained above.

In the first embodiment explained above, as illustrated in FIG. 4, the refinement unit 111B/241B is configured to determine, using the threshold TH1 and the threshold TH2 for the block size, regions used for the refinement processing and necessity of execution of the refinement processing. By specifying, as such processing, processing for respective block shapes in advance rather than the processing using the thresholds explained above, the refinement unit 111B/241B can realize the same processing.

FIG. 11 is a flowchart illustrating an example of a procedure of refinement processing performed by the refinement unit 111B of the inter prediction unit 111 of the image encoding device 100 (and the refinement unit 241B of the inter prediction unit 241 of the image decoding device 200) in the modification 1.

In step S16, the refinement unit 111B/241B determines, based on a shape of a prediction block currently being processed (for example, defined by a combination of the width and the height of the block), to which of steps S13, S14, and S15 the procedure proceeds.

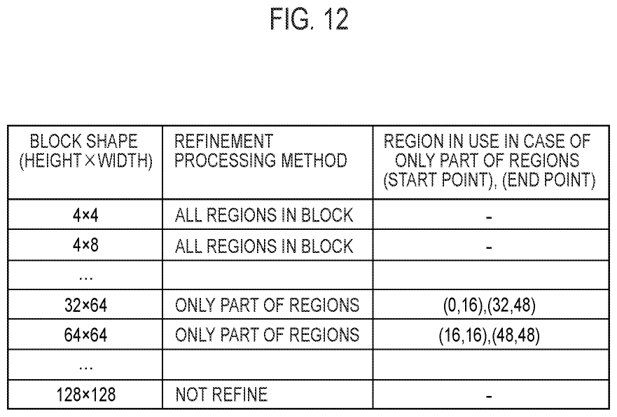

Such determination can be realized by, for example, deciding a table illustrated in FIG. 12 in advance. When the refinement processing is performed using only pixels of a part of regions in the block, it can be defined in the table in advance which region is specifically used.

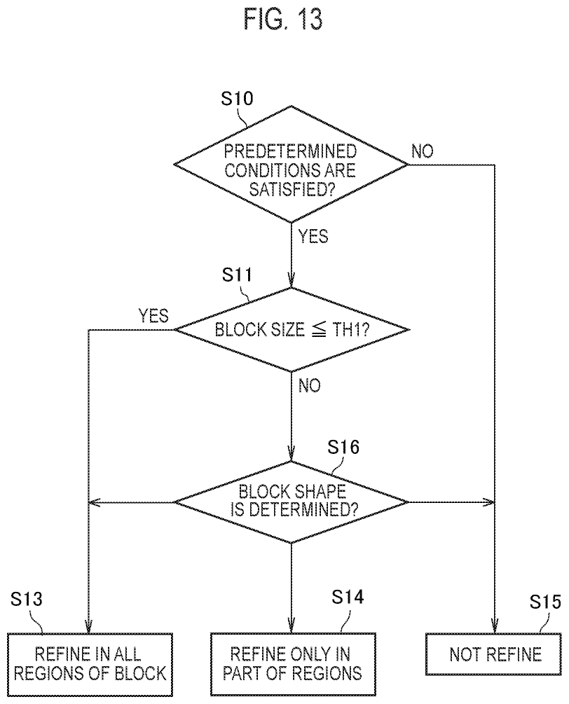

The processing using the thresholds of the block size in the first embodiment explained above and the processing for each block shape in this modification 1 can be combined. An example of a flowchart in such a case is illustrated in FIG. 13.

As illustrated in FIG. 13, for example, the refinement unit 111B/241B performs, on a block having a block size equal to or smaller than the threshold TH1, the refinement processing uniformly using pixels of all regions of the block and changes, only for a block having a block size larger than the threshold TH1, processing according to a block shape.

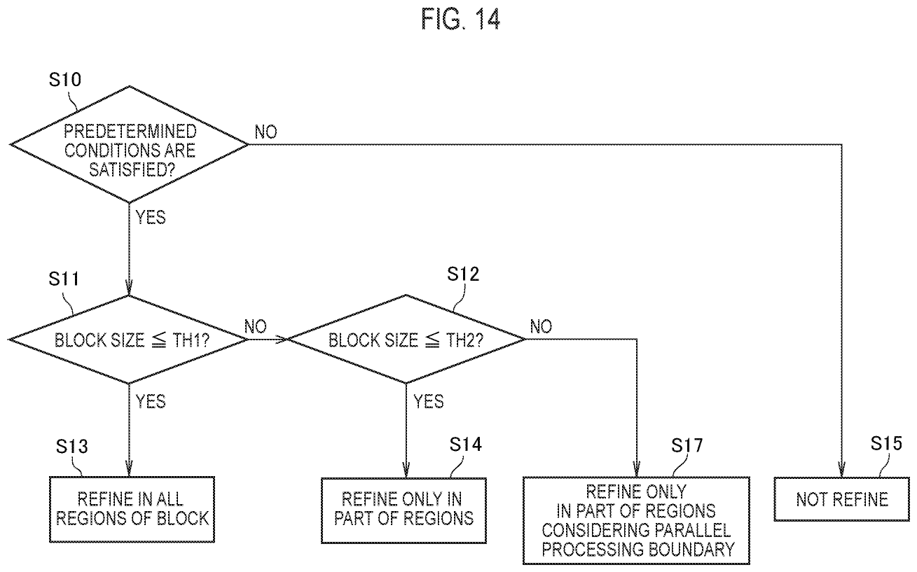

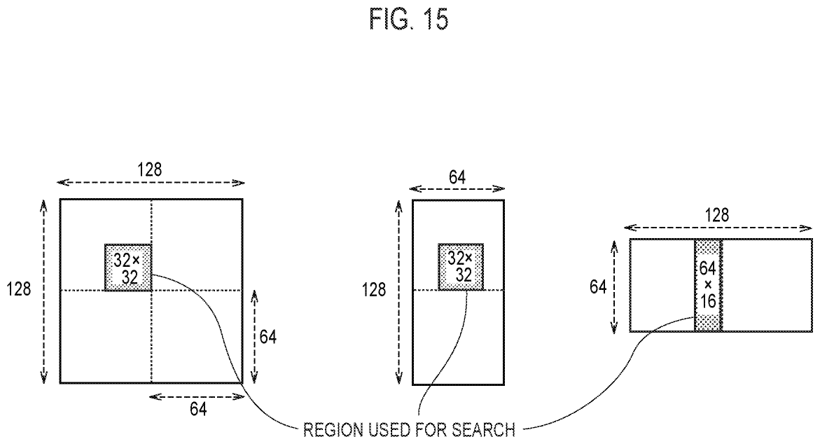

A modification 2 according to the present invention is explained below with reference to FIG. 14 to FIG. 15 focusing on differences from the first embodiment and the modification 1 explained above.

In the first embodiment explained above, as illustrated in FIG. 4, the refinement unit 111B/241B does not perform the refinement processing on the block larger than the threshold TH2. As explained above, the parallel processing of the refinement processing can be guaranteed by setting the threshold TH2 to be equal to or smaller than the parallel processing unit of encoding and decoding.

In contrast, in this modification 2, the refinement unit 111B/241B is configured to perform, in the block larger than the parallel processing unit as well, the refinement processing using only pixels of a part of regions in the block.

FIG. 14 is a flowchart illustrating an example of a procedure of refinement processing performed by the refinement unit 111B of the inter prediction unit 111 of the image encoding device 100 (and the refinement unit 241B of the inter prediction unit 241 of the image decoding device 200) in this modification 2.

As illustrated in FIG. 14, as in the first embodiment, the refinement unit 111B/241B performs, in a block larger than the threshold TH1, the refinement processing using only a part of regions in step S14.

In the first embodiment, the region used in the refinement processing in step S14 is, for example, the region in the center of the block.

On the other hand, in this modification 2, in step S17, the refinement unit 111B/241B performs, on a block larger than the threshold TH2 as well, the refinement processing using only a part of regions.

FIG. 15 illustrates an example of a region used for refinement of a motion vector in the refinement processing in step S17 at the time when a maximum size of the prediction block is set to 128×128 pixels and the parallel processing unit is set to 64×64.

Dotted lines in a block in FIG. 15 indicate a boundary of the parallel processing unit. As illustrated in FIG. 15, by defining a region used in the refinement processing not to extend across the boundary of the parallel processing unit, it is possible to carry out the refinement processing in a larger block while guaranteeing parallel processing in each processing unit. The shape of the region used for the refinement of the motion vector may be either a square or a rectangle as illustrated in FIG. 15.

Also, the image encoding device 10 and the image decoding device 30 described above may be realized by a program which causes a computer to execute functions (processes).

Note that the above described embodiments have been described by taking application of the present invention to the image encoding device 10 and the image decoding device 30 as examples. However, the present invention is not limited only thereto, but can be similarly applied to an encoding/decoding system having functions of the image encoding device 10 and the image decoding device 30.

What is claimed is:

1. An image decoding device configured to decode encoded data, the image decoding device comprising:
a decoder that acquires a motion vector from the encoded data; and
a circuit that changes, using information concerning at least one of width and height of a block in which the motion vector is used, a region used for refinement of the motion vector.

2. The image decoding device according to claim 1, wherein
when the block is larger than a first threshold, the circuit performs the refinement of the motion vector using only pixels in a part of regions in the block.

3. The image decoding device according to claim 2, wherein
the circuit performs, in the block larger than the first threshold, the refinement of the motion vector using only pixels in a region smaller than the first threshold inside the block.

4. The image decoding device according to claim 2, wherein
the circuit performs, in the block larger than the first threshold, the refinement of the motion vector using only pixels in a region in a center of the block.

5. The image decoding device according to claim 2, wherein
the image decoding device performs parallel processing for each predetermined processing unit, and
the circuit performs the refinement of the motion vector using only pixels in a region not overlapping a boundary of the parallel processing unit.

6. The image decoding device according to claim 2, wherein
the circuit doesn't perform the refinement of the motion vector in the block when the block is larger than a second threshold.

7. The image decoding device according to claim 6, wherein
the image decoding device performs parallel processing for each predetermined processing unit, and
the second threshold is configured to be smaller than the processing unit.

8. The image decoding device according to claim 1, wherein
the circuit executes processing for, according to a shape of the block, refinement the motion vector using pixels in all regions in the block, refinement the motion vector using pixels in a part of the regions in the block, or not refinement the motion vector.

9. The image decoding device according to claim 8, wherein
when a size of the block is equal to or smaller than a first threshold, the circuit performs the refinement of the motion vector using the pixels in all the regions in the block.

10. The image decoding device according to claim 1, wherein
the block is one of a prediction block or an encoding block.

11. An image encoding device configured to generate encoded data by encoding an input image signal, the image encoding device comprising:
a first circuit that searches for a motion vector through comparison of a target frame and a reference frame; and
a second circuit changes, using information concerning at least one of width and height of a block in which the motion vector is used, a region used for refinement of the motion vector.

12. A program for causing a computer to function as an image decoding device configured to decode encoded data, the image decoding device comprising:
a decoder that acquires a motion vector from the encoded data; and
a circuit that changes, using information concerning at least one of width and height of a block in which the motion vector is used, a region used for refinement of the motion vector.

13. An image processing system comprising: an image encoding device configured to generate encoded data by encoding an input image signal and an image decoding device configured to decode the encoded data, wherein
the image encoding device comprises:
a first circuit that searches for a motion vector through comparison of a target frame and a reference frame; and
a second circuit changes, using information concerning at least one of width and height of a block in which the motion vector is used, a region used for refinement of the motion vector; and
the image decoding device comprises:
a decoder that acquires the motion vector from the encoded data; and
a circuit that changes, using the information, a region used for refinement of the motion vector.
